(19) United States
(12) Patent Application Publication
(10) Pub. No.: US 2010/0020136 A1
(43) Pub. Date: Jan. 28, 2010

(54) INKJET PRINTHEAD AND METHOD OF MANUFACTURING THE SAME

(75) Inventors: Moon-chul LEE, Seongnam-si (KR); Yong-Seop YOON, Seoul (KR); Yong-Won JEONG, Seoul (KR); Dong-Sik SHIN, Suwon-si (KR); Jong-Seok KIM, Hwaseong-si (KR)

Correspondence Address: DLA PIPER LLP US, P. O. BOX 2758, RESTON, VA, 20195, US

(73) Assignee: SAMSUNG ELECTRONICS CO., LTD., SUWON-SI (KR)

(21) Appl. No.: 12/389,121

(22) Filed: Feb. 19, 2009

(30) Foreign Application Priority Data
Jul. 25, 2008 (KR) 10-2008-0072956

(51) Int. Cl. B41J 2/175; G11B 5/127

(52) U.S. Cl. 347/85; 216/27

(57) ABSTRACT

Provided are an inkjet printhead and a method of manufacturing the same. The inkjet printhead includes: a substrate having an ink feed hole extending therethrough; a chamber layer including a plurality of ink chambers above the substrate; a nozzle layer including a plurality of nozzles above the chamber layer; and at least one support beam formed in the substrate to connect inner walls of the ink feed hole.

### CROSS-REFERENCE TO RELATED PATENT APPLICATION

This application claims the benefit of Korean Patent Application No. 10-2008-0072956, filed on Jul. 25, 2008, in the Korean Intellectual Property Office, the disclosure of which is incorporated herein in its entirety by reference.

1. Technical Field

The present disclosure relates to a thermal inkjet printhead, and to a method of manufacturing the same.

2. Background of Related Art

In general, inkjet printers are devices that eject ink droplets from an inkjet printhead at a desired position on a printing medium in order to form an image of a certain color(s). Examples of such inkjet printers include shuttle type inkjet printers and line printing type inkjet printers. The shuttle type inkjet printers perform a printing operation by reciprocating an inkjet printhead in a direction perpendicular to the transfer direction of the printing medium. The line printing type inkjet printer may have a higher printing speed, and includes an array printhead having a size generally corresponding to the width of a printing medium. A plurality of inkjet printheads are arranged in such an array printhead in a predetermined form. A line printing type inkjet printer performs the printing operation by moving the printing medium while the array printhead is fixed, thereby providing a higher printing speed.

Inkjet printheads are categorized into two general types according to the ink ejection mechanism thereof. The first one is a thermal inkjet printhead that ejects ink droplets due to an expansion force of ink bubbles generated by thermal energy. The other one is a piezoelectric inkjet printhead that ejects ink droplets due to pressure applied to ink by deformation of a piezoelectric body.

An ink droplet ejection mechanism of a thermal inkjet printhead will now be described in some detail. When a pulse current is supplied to a heater including, e.g., a heating resistor, the heater generates heat and ink near the heater is instantaneously heated up to approximately 300° C., thereby making the ink boil. Accordingly, ink bubbles are formed due to evaporation of ink, and, as the bubbles expands, pressure is exerted on the ink filled in an ink chamber. As a result, ink around a nozzle is ejected through the nozzle from the ink chamber in the form of droplets.

A thermal inkjet printhead generally has a structure in which a chamber layer and a nozzle layer are sequentially stacked on a substrate, on which a plurality of material layers are formed. An ink chamber for storage of ink to be ejected is formed in the chamber layer, and a plurality of nozzles through which ink ejects are formed in the nozzle layer. In addition, an ink feed hole for supplying ink is formed through the substrate. However, the substrate may become deformed due to the weaken structural integrity of the substrate caused by the formation of the ink feed hole through the substrate. This vulnerability of an inkjet printhead may increase proportionally with the length thereof. Thus, problems caused by the vulnerability of the inkjet printheads are more serious in the line printing type inkjet printers which have been developed for high speed printing.

### SUMMARY OF DISCLOSURE

According to an aspect of the present disclosure, there is provided an inkjet printhead may include, a substrate having an ink feed hole for supplying ink; a chamber layer formed above the substrate, the chamber layer including a plurality of ink chambers; a nozzle layer including a plurality of nozzles formed above the chamber layer; and at least one support beam connecting inner walls of the ink feed hole formed in the substrate.

The support beam may connect inner walls of the ink feed hole that face each other.

The support beam may be formed at a predetermined depth from the top surface of the substrate.

The predetermined depth may be in the order of several tens of μm.

The support beam may be integrally formed with the substrate.

The substrate may be formed of silicon.

The ink feed hole may extend through the substrate substantially perpendicular to a surface of the substrate above which the chamber layer is formed.

The plurality of ink chambers may be arranged such that there is at least one ink chamber on either side of the ink feed hole.

The inkjet printhead may further include an insulation layer formed on the substrate; a plurality of heaters formed on the insulation layer; and a plurality of electrodes formed on the heaters.

The inkjet printhead may further include a passivation layer formed so as to cover the heaters and electrodes; and an anti-cavitation layer formed on the passivation layer.

According to another aspect, there is provided a method of manufacturing an inkjet printhead, which may include forming a chamber layer including a plurality of ink chambers above a substrate; forming a nozzle layer including a plurality of nozzles above the chamber layer; and forming an ink feed hole that extends through the substrate, for supplying ink to the plurality of ink chambers, the ink feed hole including at least one support beam which connects inner walls of the ink feed hole.

The support beam may connect inner walls of the ink feed hole that face each other.

The method may further include forming an insulation layer on the top surface of the substrate; sequentially forming a plurality of heaters and a plurality of electrodes on the insulation layer; and forming a passivation layer on the insulation layer so as to cover the heaters and the electrodes, before forming the chamber layer.

The method may further include forming an anti-cavitation layer on the passivation layer.

The method may further include forming a glue layer on the passivation layer.

The method may further include forming a trench extending predetermined depth from the top surface of the substrate into the substrate by etching a portion of the passivation layer, the insulation layer, and the substrate.

The depth of the trench may be approximately several mm from the top surface of the substrate.

The forming of the nozzle layer may further include forming a sacrificial layer so as to fill the ink chambers and the trench; planarizing the top surfaces of the sacrificial layer and the chamber layer; and forming the nozzle layer on the sacrificial layer and the chamber layer.

The forming of the ink feed hole may comprise etching the bottom surface of the substrate until the sacrificial layer is exposed.

The forming of the ink feed hole may comprise applying a first mask for exposing a region corresponding to the ink feed hole on the bottom surface of the substrate; applying at least one second mask for forming the support beam on the bottom surface of the substrate; etching the bottom surface of the substrate to remove the second mask and to remove the region corresponding to the ink feed hole of the bottom surface of the substrate to a predetermined depth; forming the ink feed hold and the support beam by etching the bottom surface of the substrate using the first mask until the sacrificial layer is exposed; and removing the sacrificial layer.

The material used to form the second mask may have an etching rate which is different from that of the material of the substrate.

The first mask may be formed of material comprising one of metal and photoresist. The second mask may be formed of photoresist.

The first and second masks may be formed of photoresist, the thickness of the first mask being greater than that of the second mask.

The substrate may be formed of silicon.

According to yet another aspect, there is provided a method of forming an ink supply path through a substrate of an inkjet printhead, which may include etching away a portion of the top side of the substrate to form a trench extending a first depth from the top side into the substrate; etching away portions of the bottom side of the substrate to form a beam structure portion and etched portions adjacent the beam structure portion, the beam structure portion being a portion of the substrate remaining un-etched, the etched portions extending a second depth from the bottom side of the substrate into the substrate; and further etching away both the beam structure portion and the etched portions so that the etched portions extend to portions of the trench to form the ink supply path, and such that a remaining portion of the beam structure portion extend substantially second depth from the first depth towards the bottom side of the substrate.

### BRIEF DESCRIPTION OF THE DRAWINGS

Various aspects of the present disclosure will become apparent and more readily appreciated from the following description of the embodiments, taken in conjunction with the accompanying drawings, of which:

FIG. 1 is a cross-sectional view of an inkjet printhead according to an embodiment;

FIG. 2 is a perspective view of a substrate including an ink feed hole and support beams of the inkjet printhead illustrated in FIG. 1; and

FIGS. 3 to 13 illustrate a method of manufacturing an inkjet printhead according to another embodiment.

### DETAILED DESCRIPTION OF SEVERAL EMBODIMENTS

Reference will now be made in detail to embodiments of the present invention, examples of which are illustrated in the accompanying drawings, wherein like reference numerals refer to like elements. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail.

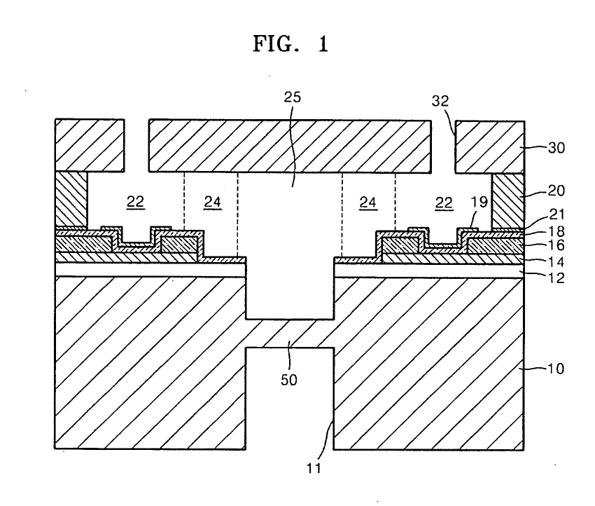

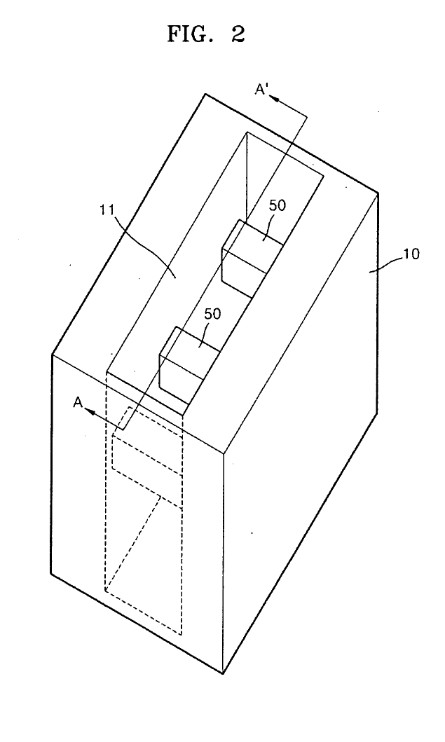

FIG. 1 is a cross-sectional view of an inkjet printhead according to an embodiment. FIG. 2 is a perspective view of a substrate including an ink feed hole and support beams of the inkjet printhead illustrated in FIG. 1.

Referring to FIGS. 1 and 2, the inkjet printhead according to an embodiment may include a substrate 10, on which a plurality of material layers are formed, a chamber layer 20 stacked above the substrate 10, and a nozzle layer 30 stacked above the chamber layer 20. The substrate 10 may be formed of silicon. An ink feed hole 11 for supplying ink is formed through the substrate 10. At least one support beam 50 which connects inner walls of the ink feed hole 11 is formed in the substrate 10 as described below. A plurality of ink chambers 22, which is to be filled with ink supplied through the ink feed hole 11, are formed in the chamber layer 20, and a plurality of nozzles 32, through which ink is ejected, are formed in the nozzle layer 30.

An insulation layer 12 for insulation and isolation between the substrate 10 and a plurality of heaters 114 may be formed on the substrate 10. The insulation layer 12 may be formed of, for example, silicon oxide. The heaters 14 for generating bubbles by heating ink are formed on the insulation layer 12. In this regard, the heaters 14 may be prepared on the bottom surface of the ink chamber 22. The heaters 14 may be formed of a heating resistive material, such as, e.g., a tantalum-aluminum alloy, tantalum nitride, titanium nitride, or tungsten silicide, but is not limited thereto. In addition, a plurality of electrodes 16 are formed on the top surface of the heaters 14. The electrodes 16 supply current to the heaters 14, and are formed of a material having excellent electric conductivity. The electrodes 16 may be formed of Al, an Al alloy, Au, Ag, or the like, but are not limited thereto.

A passivation layer 18 may be formed on the top surface of the heaters 14 and the electrodes 16. The passivation layer 18 is used to prevent the heaters 14 and electrodes 16 from being oxidized or corroded by coming in contact with the ink, and may be formed of, for example, silicon nitride or silicon oxide. In addition, an anti-cavitation layer 19 may be formed on the top surface of the passivation layer 18 above the heaters 14. The anti-cavitation layer 19 is used to protect the heaters 14 from a cavitation force generated during bubble annihilation, and may be formed of, for example, tantalum (Ta). According to an embodiment, a glue layer 21 may further be formed on the passivation layer 18 so that the chamber layer 20 is easily attached to the passivation layer 18.

The chamber layer 20 is stacked on the passivation layer 18. A plurality of ink chambers 22, which is to be filled with ink supplied from the ink feed hole 11, may be formed in the chamber layer 20. In this regard, the ink chambers 22 may be arranged on both sides of the ink feed hole 11 along the lengthwise direction of the ink feed hole 11. In addition, a plurality of restrictors 24, which are passages for connecting the ink feed hole 11 and the ink chambers 22, may be formed in the chamber layer 20. The chamber layer 20 may be formed of, for example, a polymer-based material. A nozzle layer 30 is stacked on the chamber layer 20. A plurality of nozzles 32 that eject ink are formed in the nozzle layer 30. The nozzles 32 may be formed above the ink chambers 22. The nozzle layer 30 may also be formed of, for example, a polymer based material.

As illustrated in FIG. 2, at least one support beam 50 may be formed in the substrate 10 through which the ink feed hole 11 is formed. The support beams 50 are formed so as to connect both inner walls facing each other of the ink feed hole 11. The support beams 50 may be integrally formed with the substrate 10. In this regard, the support beams 50 may be formed of silicon. The support beams 50 supports the substrate 10 by connecting inner walls of the ink feed hole 11. The support beams 50 may be formed at a predetermined depth from the top surface of the substrate 10. For example, the support beams 50 may be formed at a depth of about several μm from the top surface of the substrate 10, but the depth is not limited thereto. Thus, the support beams 50 may be formed at various depths from the top surface of the substrate 10. In addition, the depth of the support beams 50 themselves may vary. FIG. 2 illustrates three support beams 50 connecting inner walls of the ink feed hole 11, but the number of support beams 50 is not limited thereto. In addition, FIG. 2 illustrates that the support beam 50 has a rectangular cross-section, but the shape of the cross-section of the support beam 50 is not limited thereto, and the cross-sectional form of the support beam 50 may vary.

As described above, in the inkjet printhead according to an embodiment, the substrate 10 may be supported by forming at least one support beam 50 which connects two facing inner walls of the ink feed hole 11 in the substrate 10. Accordingly, vulnerability of the substrate 10 due to the ink feed hole 11 formation through the substrate 10 may be reduced. Thus, an inkjet printhead having a rigid and reliable structure may be formed. In addition, since the support beam 50 is formed at a predetermined depth from the top surface of the substrate 10, ink in the ink feed hole 11 may smoothly flow into the ink chamber 22 without flow resistance due to the support beam 50.

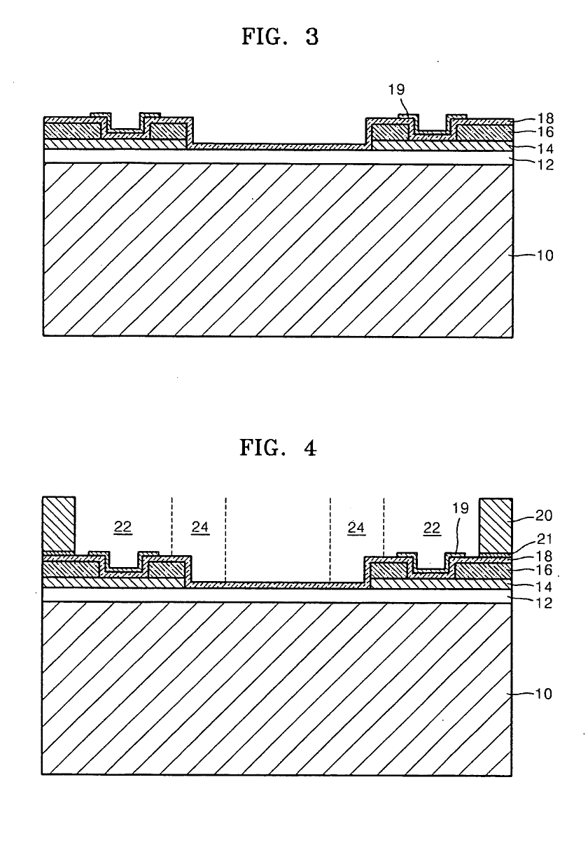

FIGS. 3 to 13 illustrate a method of manufacturing an inkjet printhead according to another embodiment.

Referring to FIG. 3, the substrate 10 is prepared, and then an insulation layer 12 is formed on the substrate 10. The substrate 10 may be a silicon substrate. The insulation layer 12 for insulation between the substrate 10 and a plurality of heaters 14 may be formed of, for example, silicon oxide. Then, the heaters 14 for generating bubbles by heating ink are formed on the top surface of the insulation layer 12. The heaters 14 may be formed by depositing a heat resistive material, such as a tantalum-aluminum alloy, tantalum nitride, titanium nitride, tungsten silicide, or the like on the top surface of the insulation layer 12, and by patterning the material. A plurality of electrodes 16 for supplying current to the heaters 14 may be formed on the top surface of the heaters 14. The electrodes 16 may be formed by depositing a metal having excellent electric conductivity, such as, e.g., Al, an Al alloy, Au, or Ag, and by patterning the metal.

A passivation layer 18 may be formed on the insulation layer 12 so as to cover the heaters 14 and the electrodes 16. The passivation layer 18 is used to prevent the heaters 14 and the electrodes 16 from being oxidized or corroded by coming into contact with the ink, and may be formed of silicon nitride or silicon oxide. An anti-cavitation layer 19 may be formed on the top surface of the passivation layer 18 above of the heaters 14. The anti-cavitation layer 19 is used to protect the heaters 14 from a cavitation force generated by the bursting of ink bubbles, and may be formed of tantalum (Ta).

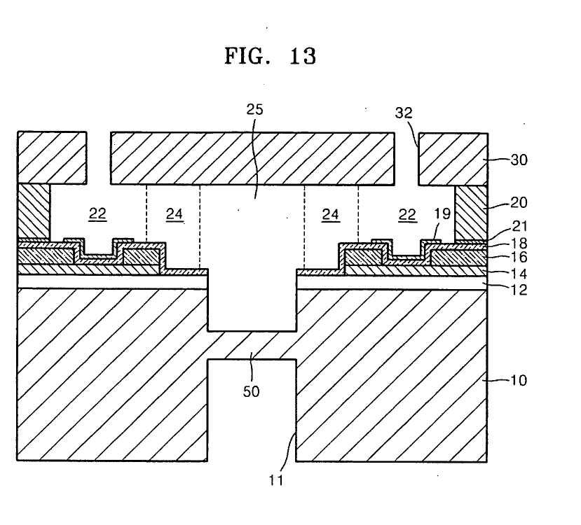

Referring to FIG. 4, a chamber layer 20 including a plurality of ink chambers 22 is stacked on the passivation layer 18. The chamber layer 20 may be formed by coating a material to cover the structure illustrated in FIG. 3, for example, a photosensitive epoxy resin, to a predetermined thickness, and patterning the material. A plurality of ink chambers 22, in which ink supplied from an ink feed hole 11 will fill, may be formed in the chamber layer 20. In this regard, the ink chambers 22 may be formed above the heaters 14. In addition, the ink chambers 22 may be arranged on both sides of the ink feed hole 11 (shown in FIG. 13). A plurality of restrictors 24, which are passages for connecting the ink feed hole 11 and the ink chambers 22, may be formed in the chamber layer 20. In addition, according to an embodiment, the method may further include forming a glue layer 21 on the passivation layer 18 so that the chamber layer 20 is easily attached to the passivation layer 18. The glue layer 21 may also be formed of, for example, an epoxy resin.

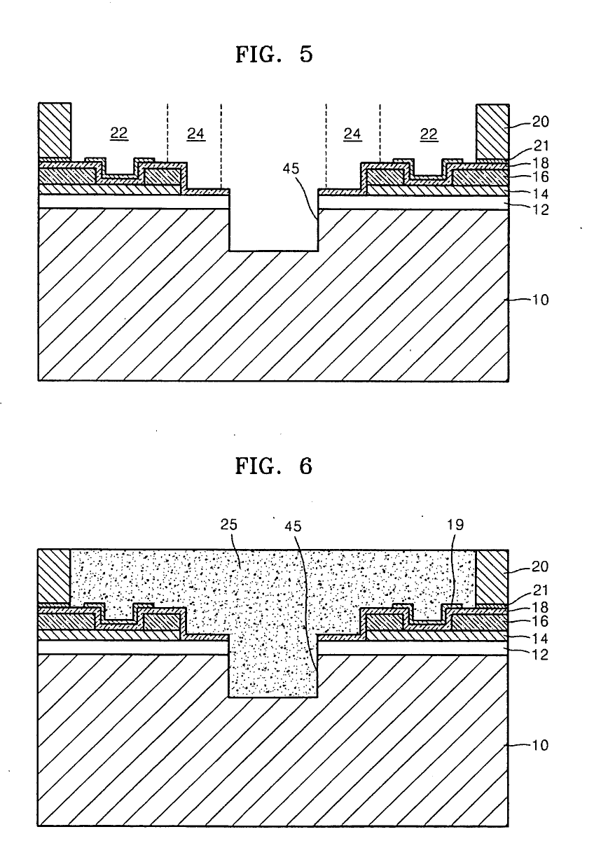

Referring to FIG. 5, a trench 45 having a predetermined depth may be formed on the substrate 10 by sequentially dry-etching the passivation layer 18, the insulation layer 12, and the upper portion of the substrate 10. In this regard, the trench 45 may be formed on the upper portion of the ink feed hole 11 (shown in FIG. 13). The trench 45 may have a predetermined depth from the top surface of the substrate 10. For example, the trench 45 may have a depth of about several μm from the top surface of the substrate 10, but the depth is not limited thereto and various depths may be employed. The depth at which the support beam 50 is formed from the top surface of the substrate 10 may be controlled by adjusting the depth of the trench 45.

Referring to FIG. 6, a sacrificial layer 25 is formed on the chamber layer 20 so as to fill the trench 45, the ink chambers 22, and the restrictors 24. The sacrificial layer 25 may be formed of a material having etch selectivity to the substrate 10, the chamber layer 20, and a nozzle layer 13 (see FIG. 13), for example, a photoresist. The method may further include planarizing the top surfaces of the sacrificial layer 25 and the chamber layer 20 after forming the sacrificial layer 25. In this regard, the top surfaces of the sacrificial layer 25 and the chamber layer 20 may be planarized using chemical mechanical polishing (CMP) process.

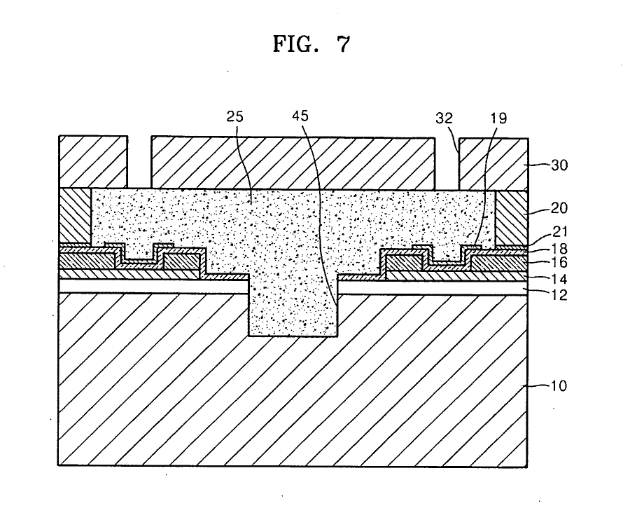

Referring to FIG. 7, a nozzle layer 30 including a plurality of nozzles 32 is formed on the top surfaces of the chamber layer 20 and the sacrificial layer 25. The nozzle layer 30 may be formed by coating a material, for example a photosensitive epoxy resin, on the top surfaces of the chamber layer 20 and the sacrificial layer 25, and by patterning the material. Accordingly, a plurality of nozzles 32 that expose the top surface of the sacrificial layer 25 are formed in the nozzle layer 30. The nozzle layers 32 may be formed above the ink chambers 22.

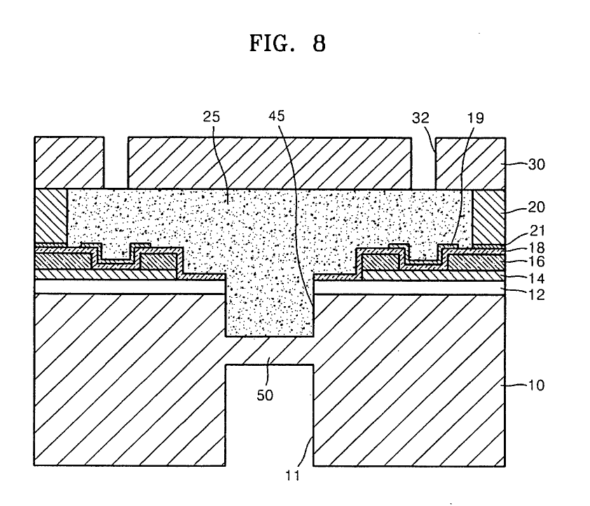

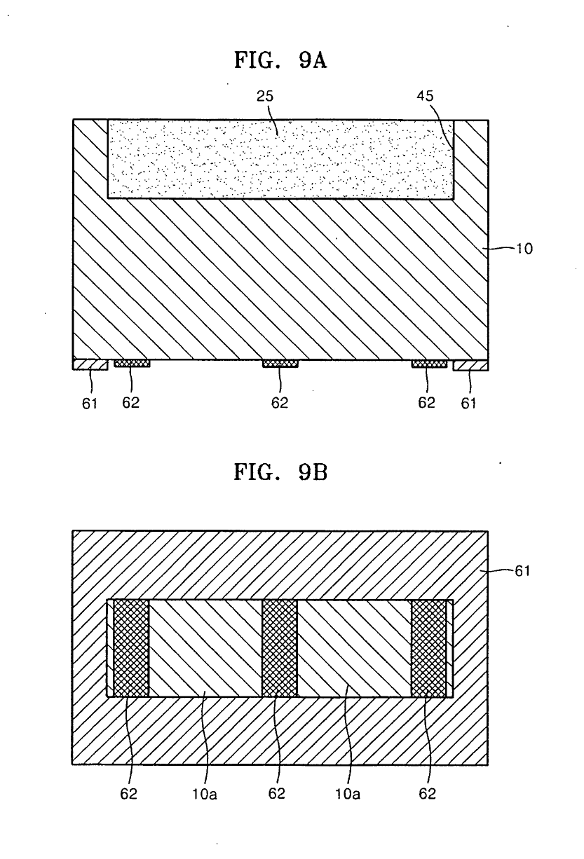

Referring to FIG. 8, a lower portion of the ink feed hole 11 for supplying ink and at least one support beam 50 are formed by etching the bottom surface of the substrate 10. The lower portion of the ink feed hole 11 and the support beam 50 will be described in detail with reference to FIGS. 9A to 12B. FIGS. 9A, 10A, 11A, and 12A are cross-sectional views taken along line A-A′ line of FIG. 2. FIGS. 9B, 10B, 11B, and 12B are bottom views of the substrate.

j Referring to FIGS. 9A and 9B, first and second masks 61 and 62 are formed on the bottom surface of the substrate 10. In-this regard, the first mask 61 is formed on the bottom surface of the substrate 10 so as to expose a region corresponding to the ink feed hole 11. Then, the second mask 62 is used to form the support beams 50 illustrated in FIG. 13, and may be formed at a region corresponding to the support beams 50 on the bottom surface of the substrate 10. As a result, the bottom surface 10a of the substrate 10, which is to be etched, is exposed through the first and second masks 61 and 62. FIGS. 9A and 9B illustrate the bottom surface 10a of the substrate 10 having three second masks 62 for forming three support beams 50. The first mask 61 may be formed of a metal such as Al or a photoresist. The second mask 62 may be formed of a photoresist. If the first and second masks 61 and 62 are formed of a photoresist, the thickness of the first mask 61 may be greater than that of the second mask 62. For example, the first mask 61 may have a thickness of about 5 to about 10 μm and the second mask 62 may have a thickness of about 1 to 3 μm but the thicknesses are not limited thereto.

In addition, the second mask 62 has an etch selectivity ratio different from that of the substrate 10. That is, the second mask 62 may be formed of a material having an etch rate different from that of the substrate 10. For example, if the second mask 62 and the substrate 10 are respectively formed of a photoresist and silicon, about 80 μm of silicon is removed while about 1.2 μm of the photoresist is removed by dry-etching. That is, if the second mask 62 is formed of a photoresist having a thickness of about 1.2 μm a support beam 50 having a thickness of about 80 μm may be formed.

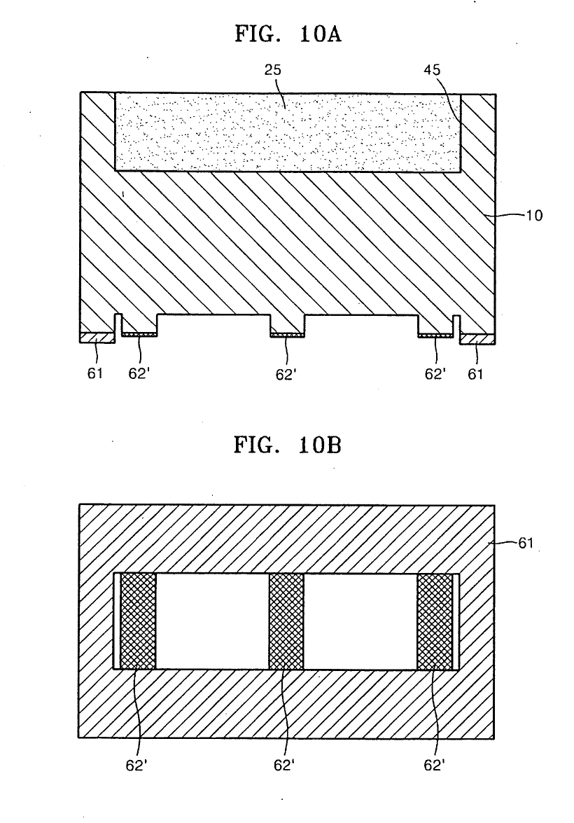

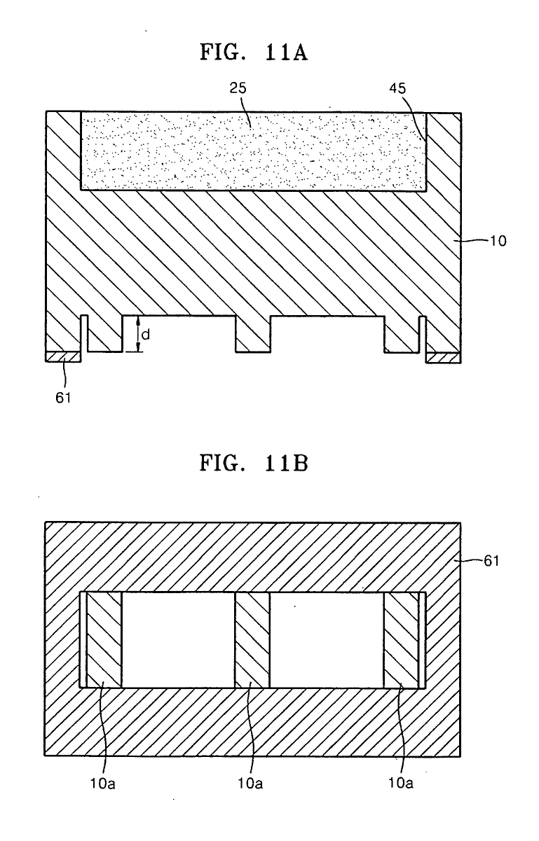

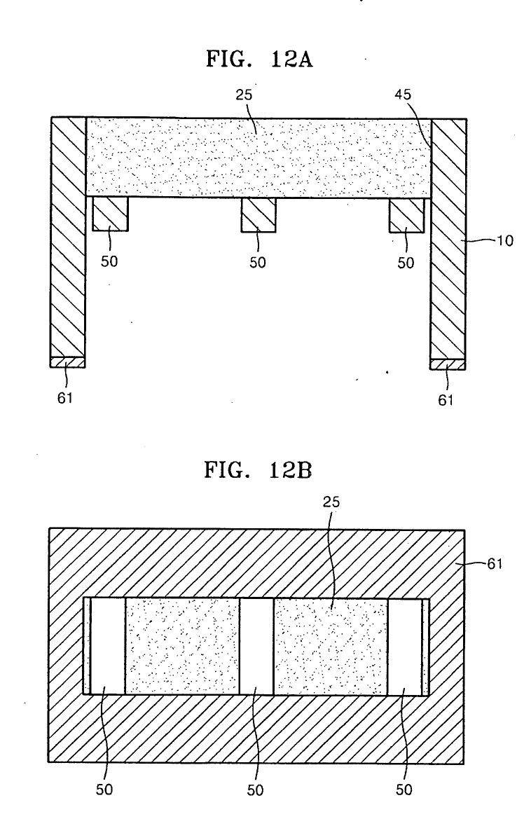

Referring FIGS. 10A and 10B, the bottom surface 10a of the substrate 10 may be dry-etched using dry-etching. In the dry-etching process, the thickness of a second mask 62′ is reduced by the etching, and the bottom surface 10a of the substrate 10 may be etched to a depth corresponding to the thickness of the second mask 62 that is removed by the etching. Meanwhile, since the first mask 61 is formed of a metal or a thick photoresist, the thickness of the first mask 61 may be maintained almost unchanged. Then, referring to FIGS. 11A and 11B, as the dry-etching is continues, the second mask 62′ is completely removed from the bottom surface 10a of the substrate 10, and the substrate 10 is etched to a predetermined depth d. The depth of the etched substrate 10 may be the thickness of the support beam 50 as will be described later.

Referring to FIGS. 12A and 12B, the bottom surface 10a of the substrate 10 is dry-etched using the first mask 61 left on the bottom surface 10a of the substrate 10 until the sacrificial layer 25 which is filled in the trench 45 is exposed to form a lower portion of the ink feed hole 11 and the support beams 50. The support beams 50 have a thickness corresponding to the depth d of the substrate 10 obtained by the etching process. Thus, the etch depth of the substrate 10 may be controlled during the process of removing the second mask 62 by regulating the thickness of the second mask 62, and thus the thickness of the support beams 50 may also be controlled. Even though the process of forming the ink feed hole 11 and the support beams 50 using dry-etching is described above, it will be apparent to those of ordinary skill in the art that the ink feed hole 11 and the support beams 50 may alternatively be formed using wet-etching.

Finally, referring to FIG. 13, the sacrificial layer 25 which is filled in the trench 45, the ink chambers 22, and the restrictors 24, is removed to complete an inkjet printhead. In particular, a predetermined etchant is injected through the nozzles 32 and the ink feed hole 11 to selectively etch the sacrificial layer 25. Accordingly, the trench 45 is connected to the lower portion of the ink feed hole 11 to complete the ink feed hole 11.

According to the present general inventive concept, the support can be realized by forming at least one support beam that connects inner walls of the ink feed hole which face each other. Therefore, the vulnerability of the substrate caused by the ink feed hole formed through the substrate may be overcome. As a result, an inkjet printhead having a robust and reliable structure can be manufactured.

While the disclosure has been particularly shown and described with reference to several embodiments thereof with particular details, it will be apparent to one of ordinary skill in the art that various changes may be made to these embodiments without departing from the principles and spirit of the invention, the scope of which is defined in the following claims and their equivalents.

What is claimed is:

1. An inkjet printhead, comprising:
a substrate having an ink feed hole for supplying ink;
a chamber layer formed above the substrate, the chamber layer including a plurality of ink chambers;
a nozzle layer including a plurality of nozzles formed above the chamber layer; and
at least one support beam connecting inner walls of the ink feed hole formed in the substrate.

2. The inkjet printhead of claim 1, wherein the support beam connects inner walls of the ink feed hole that face each other.

3. The inkjet printhead of claim 1, wherein the support beam is formed at a predetermined depth from the top surface of the substrate.

4. The inkjet printhead of claim 3, wherein the predetermined depth is in the order of several tens of μm.

5. The inkjet printhead of claim 1, wherein the support beam is integrally formed with the substrate.

6. The inkjet printhead of claim 5, wherein the substrate is formed of silicon.

7. The inkjet printhead of claim 1, wherein the ink feed hole extends through the substrate substantially perpendicular to a surface of the substrate above which the chamber layer is formed.

8. The inkjet printhead of claim 7, wherein the plurality of ink chambers are arranged such that there is at least one ink chamber on either side of the ink feed hole.

9. The inkjet printhead of claim 1, further comprising:
an insulation layer formed on the substrate;
a plurality of heaters formed on the insulation layer; and
a plurality of electrodes formed on the heaters.

10. The inkjet printhead of claim 9, further comprising:
a passivation layer formed so as to cover the heaters and electrodes; and
an anti-cavitation layer formed on the passivation layer.

11. A method of manufacturing an inkjet printhead, comprising:
forming a chamber layer including a plurality of ink chambers above a substrate;
forming a nozzle layer including a plurality of nozzles above the chamber layer; and
forming an ink feed hole that extends through the substrate, for supplying ink to the plurality of ink chambers, the ink feed hole including at least one support beam which connects inner walls of the ink feed hole.

12. The method of claim 11, wherein the support beam connects inner walls of the ink feed hole that face each other.

13. The method of claim 11, further comprising:
forming an insulation layer on the top surface of the substrate;
sequentially forming a plurality of heaters and a plurality of electrodes on the insulation layer; and
forming a passivation layer on the insulation layer so as to cover the heaters and the electrodes, before forming the chamber layer.

14. The method of claim 13, further comprising forming an anti-cavitation layer on the passivation layer.

15. The method of claim 13, further comprising forming a glue layer on the passivation layer.

16. The method of claim 13, further comprising forming a trench extending predetermined depth from the top surface of the substrate into the substrate by etching a portion of the passivation layer, the insulation layer, and the substrate.

17. The method of claim 16, wherein the depth of the trench is approximately several μm from the top surface of the substrate.

18. The method of claim 16, wherein the step of forming the nozzle layer comprises:
forming a sacrificial layer so as to fill the ink chambers and the trench;
planarizing the top surfaces of the sacrificial layer and the chamber layer; and
forming the nozzle layer on the sacrificial layer and the chamber layer.

19. The method of claim 18, wherein the step of forming the ink feed hole comprises:
etching the bottom surface of the substrate until the sacrificial layer is exposed.

20. The method of claim 18, wherein the step of forming the ink feed hole comprises:
applying a first mask for exposing a region corresponding to the ink feed hole on the bottom surface of the substrate;
applying at least one second mask for forming the support beam on the bottom surface of the substrate:
etching the bottom surface of the substrate to remove the second mask and to remove the region corresponding to the ink feed hole of the bottom surface of the substrate to a predetermined depth;
forming the ink feed hold and the support beam by etching the bottom surface of the substrate using the first mask until the sacrificial layer is exposed; and
removing the sacrificial layer.

21. The method of claim 20, wherein the material used to form the second mask has an etching rate which is different from that of the material of the substrate.

22. The method of claim 20, wherein the first mask is formed of material comprising one of metal and photoresist, and wherein the second mask is formed of photoresist.

23. The method of claim 22, wherein the first and second masks are formed of photoresist, the thickness of the first mask being greater than that of the second mask.

24. The method of claim 20, wherein the substrate is formed of silicon.

25. A method of forming an ink supply path through a substrate of an inkjet printhead, comprising:
etching away a portion of the top side of the substrate to form a trench extending a first depth from the top side into the substrate;
etching away portions of the bottom side of the substrate to form a beam structure portion and etched portions adjacent the beam structure portion, the beam stricture portion being a portion of the substrate remaining un-etched, the etched portions extending a second depth from the bottom side of the substrate into the substrate; and
further etching away both the beam structure portion and the etched portions so that the etched portions extend to portions of the trench to form the ink supply path, and such that a remaining portion of the beam structure portion extend substantially second depth from the first depth towards the bottom side of the substrate.
